(19) United States
(12) Patent Application Publication
(10) Pub. No.: US 2003/0185201 A1
(43) Pub. Date: Oct. 2, 2003

(54) System and method for 1 + 1 flow protected transmission of time-sensitive data in packet-based communication networks

(76) Inventor: John D. Dorgan, Marlboro, NJ (US)

Correspondence Address: Brian K. Dinicola, 34 Avenue E, Monroe Twp, NJ, 08831, US

(21) Appl. No.: 10/109,986

(22) Filed: Mar. 29, 2002

(51) Int. Cl. H04L 12/66; H04J 3/16

(52) U.S. Cl. 370/352; 370/408; 370/466

(57) ABSTRACT

A method of transmitting data packets in a communication network comprises receiving, at an originating node, at least one frame of time-division-multiplexed (TDM) data and converting the at least one frame of TDM data into a first flow of data packets. Each packet of the first flow includes a header identifying a packet sequence number and a first path between the originating node and a destination node. The method further includes a step of generating a second flow of data packets, the second flow of data packets being representative of the at least one frame of TDM data and including a header identifying a packet sequence number and a second path between the originating node and a destination node. The first and second flows of data packets are launched over the corresponding paths. At the receiver end, only the flow of data packets associated with the path designated as the working path is converted back into frames of TDM data and forwarded to an appropriate external interface. If monitoring of the sequence number or received rate of packets over the working path reveals a failure or poor performance, a transfer is performed such that only the flow of data packets associated with the protection path are converted into frames of TDM data.

### BACKGROUND OF THE INVENTION

1. Field of the Invention

The present invention relates generally to the transmission of packets in communication networks and, more particularly, to the protection of flows through networks against the failure of channels or sites in the network.

2. Discussion of the Prior Art

Network protection switching systems reduce the detrimental effects of failures upon subscribers. Some systems do so by switching flows away from failed parts of the network to operational parts, if any exist. The failure and the protection switching action both lead to a period of disruption to the end user. A quick protection switching response time will reduce the disruption experienced by network subscribers.

In the course of traversing a link between adjacent nodes of a communication network, signals originating at one node may encounter a path discontinuity (in an optical network, for example, this may be caused by a fiber break or an attenuation-producing bend) or an equipment malfunction that physically prevents the signals from reaching a destination node. As will be readily appreciated by those skilled in the art, a competent network designer will generally incorporate link redundancy-providing provide one or more alternate paths (“protection paths”) between the adjacent nodes so that no single point of failure (i.e., along the “working path”) can prevent data originating at a source node from reaching a destination node.

In a packet-based network, a single message is often divided into many data packets which are tagged with destination labels and sequence numbers, and directed via electrical and, optionally, optical communication paths using equipment and/or software well known in the art. The receiving system examines the header of each packet to determine whether it is part of the same message, checks its sequence number, and may also perform a check of data integrity such, for example, as a checksum, before reassembling a stream of received packets into the original message. In packet-based networks principally designed to carry non time-sensitive data, it is common for packets within a single sequence to traverse different links and nodes before arriving at the destination node. In the event a packet is lost along the way, it can be re-transmitted in a manner that is transparent to the user and without deleterious effects on the user's application.

On the other hand, the quality of real-time data such, for example, as voice or video data, is very dependent on its presentation as an uninterrupted stream. Notwithstanding the general applicability of link redundancy as a means for ensuring that data reaches its destination, a continuing need exists for a system and method that is adapted to allow a rapid transition from a working path to a protection path whereby flows of packets, representative of delay-intolerant data, can be received at a destination node with little or no interruption and whereby the quality of a connection established between interfaces served by the communication network is not impaired in a manner perceptible to end-users.

### SUMMARY OF THE INVENTION

The aforementioned need is addressed, and an advance is made in the art, by a method of transmitting data packets in a communication network that comprises receiving, at an originating node, frames of time-division-multiplexed (TDM) data and converting them into constant bit rate data packets to thereby create one or more primary or “working” packet flows destined for a destination node. Each packet so converted includes a header defining an originating and destination address and also a multiple-bit field representative of its corresponding packet sequence number. Consecutive numbers are assigned to respective packets of a primary packet flow so that, among other reasons, a determination can be made as to whether any packets are missing from a primary flow at the destination node. The header of each packet includes a multiple-bit field corresponding to a flow path identifier. The flow path identifier according to an especially preferred embodiment of the present invention

—in which fixed length Ethernet or gigabit Ethernet packets transport constant bit rate data between originating and destination node interfaces—is a virtual local area network identifier (VLAN ID) corresponding flow must traverse in order to arrive at its destination.

The method further includes a step of generating at least one secondary or “protection” flow of constant bit rate data packets from the same received TDM data frames that were used to generate a corresponding primary packet flow. That is, in accordance with the present invention, primary and seconday flows of constant bit rate packets are generated for each stream of TDM data frames arriving at the originating node of the network. In the especially preferred gigabit Ethernet packet implementation of the invention, each individual packet of a secondary packet flow differs from its primary flow counterpart only on the basis of its VLAN ID bit field. By definition, the working or primary flow path must be different from the protection or secondary flow path in order for path diversity to be maintained. By enabling the packet switching nodes of the network to distinguish between working and protection packets, the VLAN ID ensures that path diversity can be achieved in the manner intended by the network administrator.

At the destination or receiver end, only the flows of data packets characterized as working flows—by virtue of their VLAN ID—are converted back into frames of TDM data and thereafter forwarded to an appropriate external TDM interface. By way of illustrative example, the external interfaces at the originating and destination nodes may include DS1 interfaces of a private branch exchange (PBX) network and a public switched telephone network (PSTN), respectively, thereby allowing the packet-based network to transparently carry TDM data between corresponding pairs of external interfaces.

If monitoring of the sequence numbers or received rate of packets received via the working path reveals that an excessive number of packets are being lost or are subject to an unacceptable delay, a transfer operation is performed such that only the flow of data packets associated with the protection path are converted into frames of TDM data. That is, for a given flow of packets representative of TDM data and received at an originating node of the network, a receive interface at the destination node can select between alternate (i.e., redundant paths). Because this decision is made at the destination node, the transfer operation can be implemented rapidly—say, on the order of 50 msec or less, and any disruption in the flow rate of data between the external TDM interfaces served by the originating and destination node is minimized.

A transmitter for use in a packet-based communication network according to the present invention comprises a first interface for receiving, at an originating node of the communication network, frames of time-division-multiplexed (TDM) data intended for delivery to a destination node of the communication network. The transmitter further includes a TDM frame-to-data packet converter operatively associated with the first interface and operative to convert frames of TDM data received via the first interface into a first primary or “working” flow of data packets. Each data packet of the first primary flow includes a header identifying a packet sequence number and a first path between the originating node and a destination node. The TDM frame-to-data packet converter is further operative to generate a first secondary or “protection” flow of data packets, the first secondary flow of data packets being representative of frames of TDM data received at the first interface and including a header identifying a packet sequence number and a second path between said originating node and said destination node. The transmitter further includes second and third interfaces for launching the first primary and secondary flows of data packets, respectively, over a corresponding one of the first and second paths.

In accordance with an especially preferred embodiment of the present invention, the frames of TDM data are received as an electrical signal at the first interface, the TDM frame-to-data packet converter being adapted to supply the primary and secondary flows of data packets as optical signals to said second and third interfaces, respectively, for transmission over optical links to the destination node.

A receiver for use in a packet-based communication network according to the present invention comprises a packet-to-TDM-frame converter having a first interface for supplying at a destination node of the communication network, frames of time-division-multiplexed (TDM) data to an external TDM interface. The packet-to-TDM frame converter further includes second and third interfaces for receiving primary and secondary flows of data packets, respectively. The primary and secondary flows of data packets are representative of the same TDM data to be supplied to the external TDM interface, but have arrived via corresponding first and second paths designated as a working path and a protection path, respectively. The receiver includes a packet inspection circuit operative to examine a packet sequence number in the header of each packet arriving via the working path to determine whether packets are missing. The packet inspection circuit is further operative to examine the arrival rate of packets arriving via the working path to determine whether those packets are being unacceptably delayed. For purposes of comparison, the packet inspection circuit is also operative to examiner the arrival rate and continuity of packets arriving via the protection path.

So long as the performance of the working path is acceptable in terms of transmission rate and sequence continuity, the packet flow arriving via the working path continues to be selected for further processing by the packet-to-TDM-frame converter. If only a few packets have been dropped as they traverse the working path identified in the packet header, the receiver can be adapted to insert one or more replacement or “dummy” packets in their place. The thus re-constructed packet flow is then directed to an overhead removal module, which strips away the header and other non-payload data. In a reassembly module, the data payload from the packet flow is used to reconstitute the frames of TDM data and the signal thus generated is output at the first interface for delivery to the external TDM interface (e.g., a T1 interface of a private branch exchange or of a public switched telephone network). To the extent only a few random bits were inserted into a given re-constituted TDM stream, a user will not perceive any diminution in the quality of the voice conversation.

In the event that too many packets are missing from a primary packet flow arriving via the designated working path, or that an unacceptable level of delay is detected between the packets of that flow, then the packet-to-TDM-frame converter instead selects the secondary packet flow arriving on the designated protection path for processing into TDM frames.

### BRIEF DESCRIPTION OF THE DRAWINGS

The various features and advantages of the invention will be better understood by reference to the detailed description which follows, taken in conjunction with the accompanying drawings, in which:

FIG. 1 is a block circuit diagram of a network configuration accommodating the bi-directional transmission, as packets, of blocks of bits representative of frames of time-division-multiplexed (TDM) data in accordance with an illustrative 1+1 flow protection embodiment of the present invention;

FIG. 2 is a simplified block schematic diagram depicting the flow of packets from one node to an adjacent node in the exemplary network of FIG. 1; and

FIG. 3 is a schematic block diagram illustrating, in greater detail, the conversion of TDM frames to data packets (and vice-versa) and subsequent processing to enhance the likelihood of receipt at a destination node in accordance with the teachings of the present invention.

### DETAILED DESCRIPTION OF THE INVENTION

Throughout this specification the term “network” is used in a generic sense to describe a set of two or more sites or “nodes” and one or more links that connect those nodes together in any topology. A network supports the end-to-end transfer of flows between nodes across a concatenation of one or more links within that network. Each link is unidirectional, has one source end, and has one or multiple destination ends. Each link transfers a flow or flows from the source end to one or more destination ends. A flow transmitted from a node onto an operational link is transported to the destination node or nodes. To form a bi-directional communication channel between two nodes, links can be assembled as contra flowing pairs.

It is important to note that the nature of the flow in one direction need not be the same as the flow in the opposite direction. Each site is able to transmit one or more flows onto one or more links, and to receive flows from one or more links. Each link at each node is either an incoming link or an outgoing link depending on the direction of flow carried by that link. The receipt of any flow by a node from an incoming link may become unreliable while that link has failed. The transmission of a flow from a node may become unreliable when the node has failed.

Throughout this specification, the word “flow” is intended to denote the flow of packets —at least some of which are representative of time-sensitive data—between sites. In accordance with an especially preferred embodiment of the present invention, some of the packets are representative of constant bit rate data such, for example, as voice data, being exchanged between two sites. Such packets typically require a constant arrival rate (i.e., inter-packet spacing) at a destination site in order to provide an expected quality of service to the subscribers. As will be readily appreciated by those skilled in the art, a single link can simultaneously carry one or more distinct and parallel flows. A single physical medium may also carry distinct and opposing links or flows.

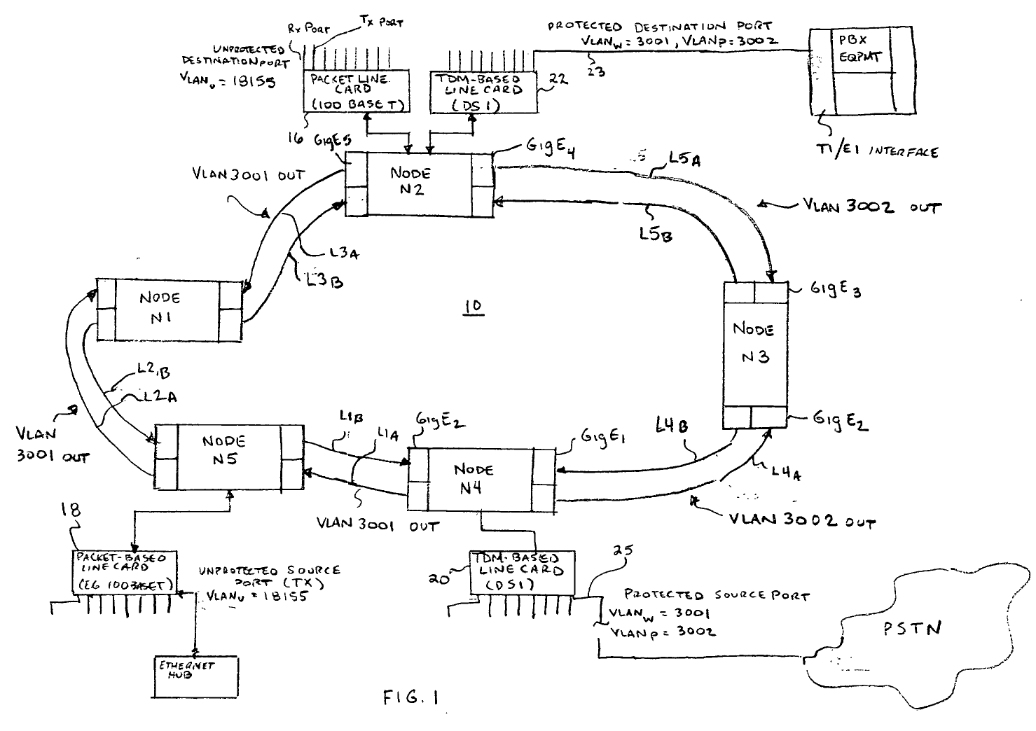

FIG. 1 illustrates an example of a packet-based network 10 employing path redundancy to ensure that frames of time division multiplexed (TDM) data received at an interface of an originating node (e.g., one of nodes N2 and N4) of network 10 are reliably delivered—via an interface of a destination node (e.g., the other of nodes N2 and N4) of network 10—to the external interface for which those frames are destined. In the illustrative example of FIG. 1, two types of network terminating interfaces are depicted: packet terminating interfaces 16 and 18 and TDM frame terminating interfaces 20 and 22. For the purposes of this specification a TDM frame terminating interface as interfaces 20 and 22 is intended to mean an interface configured for connection to an external TDM interface such, for example, as the DS1 (T1/E1) interface of a private branch exchange (PBX)) or of a public switched telephone network (PSTN). In the illustrative example depicted in FIG. 1, the TDM frame terminating interface 22 is configured as a DS1 line card for having receive/transmit (RX/TX) ports as TX port 23 for connection to a remote enterprise PBX system (not shown) while TDM frame terminating interface 20 is configured as a DS1 line card having RX/TX ports as RX port 25 for connection to the TX port of a PSTN external interface (not shown).

In contrast, a packet terminating interface, as interfaces 16 and 18, is intended to mean any interface configured for direct connection to an independent packet based network such, for example, as a local area network (LAN) at a subscriber location. In the latter regard, it will be readily appreciated by those skilled in the art that various suitable packet formats—including 10BaseT, 100BaseTX, or Gigabit Ethernet are applicable to the implementation of packet terminating interfaces. In the illustrative example of FIG. 1, packet terminating interfaces 16 and 18 are configured as 100BaseTX line cards with each having a plurality of RX/TX ports to accommodate, for example, the exchange of packets between a local area network (LAN) having a hub (not shown) connected to RX/TX ports of interface 18 and a LAN having a hub (not shown) connector to the RX/TX ports of interface 16.

In accordance with the illustrative embodiment of FIG. 1, the flows of packets exchanged between the various ports of TDM interfaces as DS1 interfaces 20 and 22 are said to be protected, while those being exchanged between the ports of the packet terminating interfaces as 100BaseTX interfaces 16 and 18 are said to be unprotected. As will soon be explained in greater detail, the distinction between the two lies in the fact a protected flow has both a working and a redundant, protection flow of packets, wherein an unprotected flow has only a single flow. In accordance with the illustrative embodiment of FIG. 1, the path associated with each flow is defined by a virtual local area network identifier (VLAN ID) contained in the header of each packet. Based on the VLAN ID, a packet switch at each node is able to direct the packets of each flow to the appropriate TX port. Thus, for example, TDM data received at protected source port 25 of node N4 is converted into two flows of packets, one of which, whose packets are identified by VLAN ID 3001 in their header, is designated the working flow and the other, whose packets are identified by VLAN ID 3002 in their header, is designated the protection flow. Accordingly, if all links and components of network 10 are functioning properly, both the working and protection flows will arrive at the destination node that, for VLAN 3001 and 3002, is node N2 (FIG. 1). Unprotected packet flows such as the one identified by VLAN ID 18155 in FIG., can be routed along any desired path between interfaces 16 and 18.

Each DS1 interface in the illustrative embodiment of FIG. 1 is programmed with a unique MAC address. A VLAN ID is assigned per DS1 TX and RX port. The DS1 card's MAC address and a port's VLAN ID, in combination, uniquely identify each individual DS1 port in a node. A unique VLAN ID is assigned to each DS1 connection and will be assigned to each DS1 port that constitutes the connection. The same configuration approach would be used for any other type of TDM-based interface with which a node of network 10 must interact.

In accordance with the present invention, data originating at any of the nodes N1 through N5 can be transported as packets to any destination node within network 10. In the illustrative embodiment, the data is transparently exchanged between nodes as gigabit Ethernet packets having packet header with multiple bit fields for representing a source address, a destination address, the aforementioned VLAN ID and, for a purpose which will be described shortly, a sequence number. It will, of course, be readily appreciated by those skilled in the art that a variety of formats, protocols and standards have been proposed and adopted with respect to the transmission of data as blocks of bits arranged in packets. Thus, although a gigabit Ethernet arrangement is favored based on considerations of commercial availability and interoperability, such implementation is described herein for purposes of illustrative example and convenience only. As such, other suitable packet formats may be adopted as they become more popular. It suffices to say that the packet-based implementation of the present invention is completely transparent to the format of the data applied to its terminal interfaces.

To this end, for example, frames of TDM data received at interfaces 20 and 22 are first converted into a format that is compatible for transmission over the packet-based network 10 of FIG. 1. Because the synchronization timing information normally included in a transmitted stream of TDM frames, to ensure compliance with the relevant Telecordia standard for DS1 interfaces, is lost when the TDM frames are mapped to a flow of data packets in accordance with the present invention, it is necessary to utilize some other mechanism for distributing the timing information needed to synchronizing the TDM frame terminating interfaces to a common reference clock. A suitable technique for this is disclosed in U.S. patent application Ser. No. ______, filed on Mar. 29, 2002 and entitled “System and Method for Clock Synchronization in Packet-Based Networks”, the disclosure of that application being expressly incorporated herein in its entirety. A variety of alternative techniques, however, are also commercially available, though they are characterized by greater cost and complexity.

In any event, and with continued reference to FIG. 1, it will be seen that multiple communication paths are possible between any two nodes, as, for example, between nodes N2 and N4. On the one hand, packets originating at node N4 may traverse links L1, L2 and L3 by way of intermediate nodes N1 and N5 before reaching node N2. Alternatively, however, those packets may traverse links L4 and L5 by way of intermediate node N3 before reaching node N2. As will be readily ascertained by those skilled in the art, the same holds true in the reverse direction. Either of these paths can serve as the path for the working flow, as defined by VLAN 3001, and the other can serve as the path for the protection flow, as defined by VLAN 3002.

It will be readily appreciated by one skilled in the art that the network administrator may explicitly configure (e.g., via SNMP or CLI interface) the binding between the DS1 port at node N4 and the DS1 port at node N5 using a selected VLAN ID. For example, by assigning the same VLAN ID (e.g., VLAN 3001) to the DS1 port in node N4 and the DS1 port in node N2, they are made members of the same virtual network. In accordance with a preferred embodiment of the invention, a range of numerical values are reserved for protected VLAN switching at each node. Such a reservation is beneficial because it ensures that no provisioning is required on the intermediate nodes. There is no provisioning required on the intermediate nodes in the accordance with the especially preferred embodiment because every gigabit Ethernet ports—over which packets are exchanged between nodes—is a member of all the valid VLANs by default.

In the illustrative embodiment of FIG. 1, each of nodes N2-N5 are connected to one another via optical links arranged to couple each respective packet interface at one node, as first gigabit Ethernet interface GigE1 of node N4, to a corresponding packet interface of an adjacent node, as gigabit Ethernet interface GigE2 of intermediate node N3. Intermediate node N3, in turn is linked to node N2 by interfaces GigE3 and GigE4. As will be described in greater detail later, each packet interface as gigabit Ethernet interfaces GigE1 through GigE4 consists of TX and RX packet flow queues, a switch card/packet bus backplane interface, a TX and RX high speed packet bus backplane, and an Ethernet switch fabric card/packet backplane interface. Connections between a node and local customer premises equipment at lower line rates can be accommodated via, for example, a 100BaseT interface as interface 16 of Node N2. In a conventional manner, such an interface includes an encoder, line interface unit, and scrambler to provide an electrical signal. Optical signals in the 100Base FX can also be implemented.

Owing to the distinction between the non time-sensitive data packets typically received at a packet terminating interface as interfaces 16 and 18, and the very time-sensitive data packets obtained following the conversion of the frames of TDM received at the interfaces 20 and 22, it is an objective of the invention to employ redundant flow protection in order to ensure that the time needed to recover from a failure or malfunction along one of the available paths between two nodes, as nodes N2 and N4, is sufficiently short as to prevent a disruptive loss of data that is perceptible to network subscribers or users.

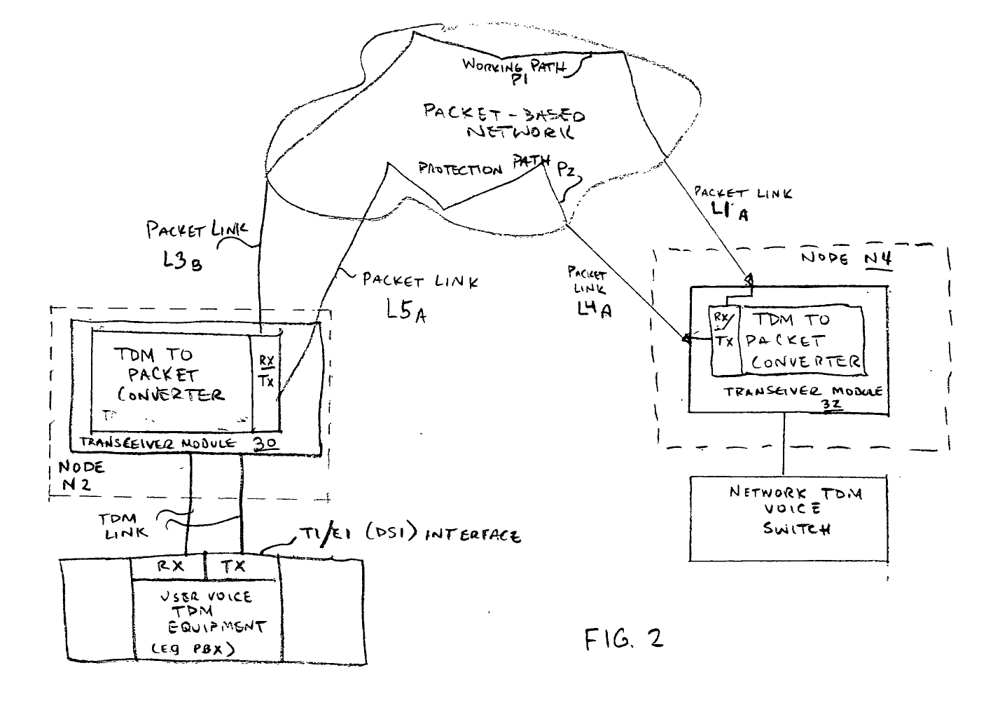

Turning now to FIG. 2, there is shown a simplified block schematic view depicting the redundant connectivity between nodes N4 and N2 of network 10. For clarity of illustration, the links L1-L3 and intermediate nodes N1 and N5 are collectively identified as bi-directional path P1 and the links L4 and L5 and intermediate node N3 are collectively identified as bi-directional path P2. Indeed, it should be noted at this point that network 10 may include any number of intermediate nodes and, conversely, either or both of the intermediate nodes N2 and N4 shown in FIG. 1 may be omitted in favor of direct interconnections between nodes N2 and N4.

In the illustrative configuration of FIG. 2, bi-directional path P1 is designated as the working path between nodes N4 and N2, while bi-directional path P2 is designated as the protection path. To accommodate the bandwidth demands of modern communication networks, each of paths P1 and P2 comprises at least one pair of optical fiber links—each fiber link of a pair being arranged to carry traffic to or from one node to the other—the paths P1 and P2 being sufficiently diverse as to diminish the likelihood that an event causing a disruption in the flow of packets along one of them would produce the same result in the other.

It will be readily appreciated by those skilled in the art that each of nodes N4 and N2 will simultaneously operate as both an originating node and a destination node in order to accommodate the exchange of Lime sensitive voice data between user voice TDM equipment (e.g. PBX) and the TDM switch of a public switched telephone network (PSTN) (neither of which are shown). To this end, each of nodes N4 and N2 includes a transceiver module indicated generally at reference numeral 30 and 32, respectively. Each transceiver module consists of TX and RX packet flow queues, a switch card/packet bus backplane interface, a TX and RX high-speed packet bus backplane, and an Ethernet switch fabric card/packet backplane interface.

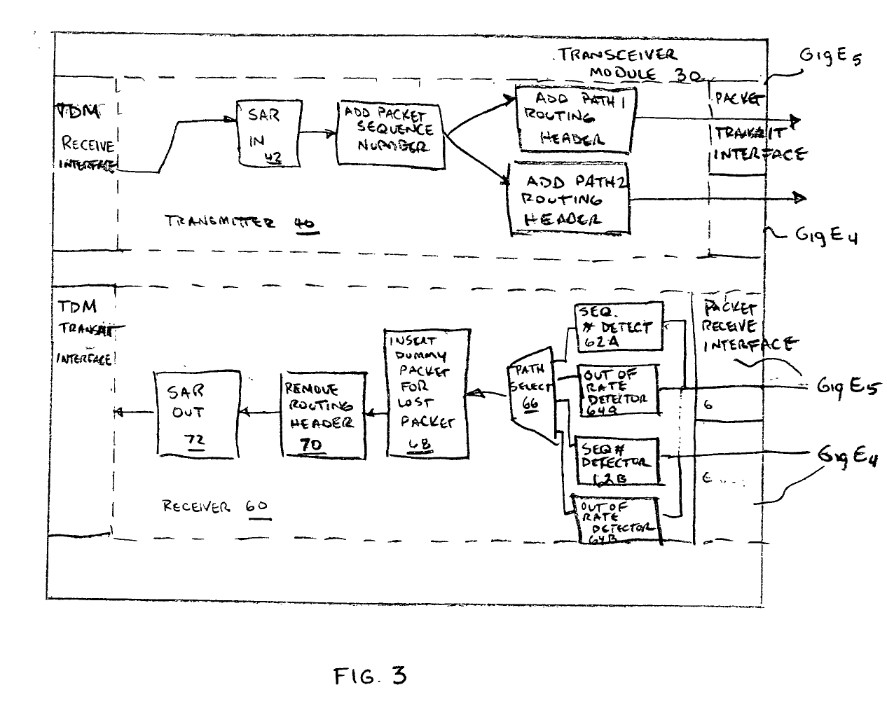

In any event, and with particular reference now to FIG. 3, it will be seen that each transceiver module as module 30 includes a transmitter portion 40 and a receiver portion 60. Essentially, transmitter 40 comprises at least one bi-directional TDM frame receiving interface port, as RX/TX ports of the first interface 20 of node N4 in FIG. These ports are adapted to exchange frames of time division multiplexed data with an external interface port, as a DS1 interface port of a PBX. TDM frames are received at the first interface and directed to a segmentation and reassembly (SAR) module 42. Essentially, SAR module 42 takes the data from the received TDM frames and sequentially generates a flow of constant bit rate, fixed length packets whose payload will be used to transport the TDM data by way of a packet-based network. Each packet of a flow is assigned a respective sequence number, via sequence generator module 44, the sequence number being represented by a multiple bit field either in the header of the packet or in some portion of the packet payload specifically reserved for this purpose. With continued reference to FIG. 3, it will be seen that the reassembled data packets representing the constant bit rate flow is divided into two flows, with the packets of each respective flows now having a routing header appended to it, the header including the appropriate VLAN ID, the MAC source address for the corresponding TDM based interface via which the TDM stream was received, and the MAC destination address for the TDM based interface (at a destination node) to which the TDM stream is to be transparently transported.

At the receiver (i.e., the destination node for a given VLAN), the sequence number and inter-packet spacing (i.e., arrival rate of packets) in a corresponding flow is monitored by respective first and second sequence and rate detectors indicated generally at 62a and 62b and 64a and 64b, respectively.

Either one of these monitored criteria might form the basis of a protection switching decision. For example, in the illustrative example of FIGS. 1-3, a 3-bit field is used to number the packets in each protected flow. When the receiver of a protected flow interface detects the reception of an unacceptable number of out-of-sequence voice packets in the working flow, path selector 66 is directed to output the protection flow to module 68, so that the protection flow packets are thereafter used in the reassembly of TDM frames in accordance with the present invention. Likewise, if the receiver of a protected flow interface detects that the average packet arrival rate is either too fast (which can cause a buffer overrun at the TDM interface) or too slow (which can cause a buffer under run), path selector 66 is directed to output the protection flow to module 68, so that the protection flow packets are thereafter used in the reassembly of TDM frames in accordance with the present invention.

In the event a packet is dropped only rarely as the flow traverses the working path (VLAN 3001 in the embodiment of FIG. 1), a path selector 66 directs the working flow to a bit stuffing module 68 that is adapted to insert a “dummy packet” whose sole purpose is to ensure an output that is synchronous with the input required by the TDM interface. If no dummy packets are required, the packets proceed to a header removal module 70, which essentially removes the header that had been added at the transmitter to provide the VLAN ID and MAC information needed to get the packets to their destination. In SAR module, the payload of each arriving packet in a flow is mapped sequentially to a TDM frame being constructed. Although the size of each fixed length packet in a data flow substantially is a parameter which admits of some variation, it is believed that size of less than 68 bytes, and preferably significantly less (on the order of 32 bytes) will produce better results than longer packets. As such, a fairly large number of packets must be processed in order to reconstruct each TDM frame.

The embodiments discussed and/or shown herein are by way of illustrative example only. They are not exclusive ways to practice the present invention, and it should be understood that there is no intent to limit the invention by such disclosure. Rather, it is intended to encompass all modifications and alternative constructions and embodiments that fall within the scope of the invention as defined by the appended claims.

What is claimed is:

1. A method of transmitting data packets in a communication network, comprising the steps of:
receiving, at an originating node, at least one frame of time-division-multiplexed (TDM) data;
converting said at least one frame of TDM data into a first flow of data packets, each packet of said first flow including a header identifying a packet sequence number and a first path between said originating node and a destination node;
generating a second flow of data packets, said second flow of data packets being representative of said at least one frame of TDM data and including a header identifying a packet sequence number and a second path between said originating node and a destination node; and
launching at least one of said first and second flows of data packets over one of said first and second paths, respectively.

2. The method of transmitting data packets according to claim 1, wherein each packet of said first and second flows of data packets has a fixed byte length.

3. The method of transmitting data packets according to claim 1, wherein said data packets are gigabit Ethernet packets.

4. The method of transmitting data packets according to claim 1, wherein each of said first and second flows of data packets are launched over a corresponding one of said first and second paths during said launching step.

5. The method of transmitting data packets according to claim 4, further including a step of monitoring to detect a flow irregularity in at least one of the first path and the second path.

6. The method of transmitting data packets according to claim 5, wherein said step of monitoring includes detecting the sequence number of received packets in one of said first flows and said second flows to determine if packets are being dropped along one of the first path and the second path.

7. The method of transmitting data packets according to claim 5, wherein said step of monitoring includes detecting an average rate at which packets are received over at least one of the first and the second paths.

8. The method of transmitting data packets according to claim 5, wherein said first path is a working path and said second path is a protection path, the method further including a step of selecting the first flow of data packets for further receive processing if no flow irregularity is detected during said monitoring step and selecting the second flow of data packets for further receive processing if a failure is detected during said monitoring step.

9. The method of claim 1, further including a step of converting one of said first and second flows of data packets back into at least one frame of TDM data.

10. The method of claim 9, further including a step of discarding the other of said first and second flows of data packets.

11. A transmitter for use in a packet-based communication network, comprising:
a first interface for receiving, at an originating node of the communication network, frames of time-division-multiplexed (TDM) data intended for delivery to a destination node of the communication network;
a TDM frame-to-data packet converter operatively associated with said first interface and operative to convert received frames of TDM data into a first flow of data packets, each packet of said first flow including a header identifying a packet sequence number and a first path between said originating node and a destination node,
wherein said TDM frame to data packet converter is further operative to generate a second flow of data packets, said second flow of data packets being representative of frames of TDM data received at the first interface and including a header identifying a packet sequence number and a second path between said originating node and said destination node; and
second and third interfaces for simultaneously launching said first and second flows of data packets, respectively, over a corresponding one of said first and second paths.

12. The transmitter according to claim 11, wherein said TDM frame to data packet converter is adapted to supply said first and second flows of data packets as optical signals to said second and third interfaces, respectively.

13. The transmitter according to claim 11, wherein said first and second flows of data packets are gigabit Ethernet packets.

14. The transmitter according to claim 11, wherein each data packet of said first and second flows of data packets has a fixed length in bytes.

15. A receiver for use in a packet-based communication network, comprising:
a packet-to-TDM-frame converter having
a first interface for supplying at a destination node of the communication network, frames of time-division-multiplexed (TDM) data to an external TDM interface,
second and third interfaces for receiving from an originating node, over first and second paths, respectively, first and second flows of data packets, each of said first and second flows of data packets each being representative of identical TDM data to be supplied to the external TDM; and
a monitoring module for detecting a flow irregularity in at least one of the first path and the second path,
wherein said packet-to-TDM-frame converter is responsive to the monitoring module to select one of the first and second flows of data packets for conversion into the frames of TDM data and to supply, via the first interface, and to convert only those packets of the selected flow into TDM data frames.

16. The receiver according to claim 15, wherein the monitoring module includes a packet inspection circuit operative to examine a packet sequence number in the header of each packet arriving at the second and third interfaces to determine whether packets are missing.

17. The receiver according to claim 16, wherein the monitoring module includes a packet inspection circuit operative to examine the arrival rate of packets arriving at the second and third interfaces to determine whether packets are arriving at a rate below a pre-established threshold.
